(19) United States
(12) Patent Application Publication
(10) Pub. No.: US 2021/0215497 A1
(43) Pub. Date: Jul. 15, 2021

(54) CONTROL APPARATUS, SYSTEM, NON-TRANSITORY COMPUTER-READABLE MEDIUM, TERMINAL APPARATUS, AND VEHICLE OPERATION SUPPORT METHOD

(71) Applicant: TOYOTA JIDOSHA KABUSHIKI KAISHA, Toyota-shi (JP)

(72) Inventors: Takashi HORIGUCHI, Toyota-shi (JP); Hideo HASEGAWA, Nagoya-shi (JP); Chikage KUBO, Chofu-shi (JP); Kentaro TAKAHASHI, Toyota-shi (JP); Yusuke KOBAYASHI, Ota-ku (JP); Minoru KUBOTA, Toyota-shi (JP)

(73) Assignee: TOYOTA JIDOSHA KABUSHIKI KAISHA, Toyota-shi (JP)

(21) Appl. No.: 17/128,630

(22) Filed: Dec. 21, 2020

(30) Foreign Application Priority Data
Jan. 9, 2020 (JP) 2020-002397

(51) Int. Cl. G01C 21/34; G01C 21/36; G08G 1/0969; G08G 1/123

(52) U.S. Cl. CPC G01C 21/3484; G08G 1/123; G08G 1/0969; G01C 21/3614

(57) ABSTRACT

A control apparatus includes a controller. The controller is configured to: extract, from a plurality of users, users with a common point of interest as users to be boarded together to a vehicle, based on first information which indicates a point of interest for each of the plurality of users; and calculate a driving route for the vehicle to travel sequentially through candidate boarding sites for the extracted users to arrive at the common point of interest for the extracted users as indicated by the first information, the candidate boarding sites being indicated by second information which indicates a candidate for a boarding site for each of the plurality of users.

### CROSS-REFERENCE TO RELATED APPLICATION

This application claims priority to Japanese Patent Application No. 2020-002397 (filed on Jan. 9, 2020), the entire contents of which are incorporated herein by reference.

### TECHNICAL FIELD

The present disclosure relates to a control apparatus, a system, a program, a terminal apparatus, and a vehicle operation support method.

### BACKGROUND

Patent Literature (PTL) 1 describes a technology for generating a travel plan which incorporates a destination of interest that is common to a plurality of users who belong to the same group and satisfies a travel period designated by the group.

### CITATION LIST

### Patent Literature

PTL 1: JP 2018-101187 A

### SUMMARY

According to the technology of PTL 1, no travel plan is generated for users unless the users originally belong to the same group, even if a destination of interest is common to some of the users. Thus, users who are interested in the same place are less likely to have an opportunity to meet each other.

It would be helpful to enable users who are interested in the same place to readily have an opportunity to meet each other.

An control apparatus according to an embodiment disclosed herein includes a controller, wherein the controller is configured to:

extract, from a plurality of users, users with a common point of interest as users to be boarded together to a vehicle, based on first information which indicates a point of interest for each of the plurality of users; and calculate a driving route for the vehicle to travel sequentially through candidate boarding sites for the extracted users to arrive at the common point of interest for the extracted users as indicated by the first information, the candidate boarding sites being indicated by second information which indicates a candidate for a boarding site for each of the plurality of users.

A program according to an embodiment disclosed herein is configured to cause a computer to execute operations. The operations include:

receiving a manipulation made by at least one user in a plurality of users to select a point of interest;

transmitting, to a control apparatus, information which indicates the point of interest selected by the at least one user and information which indicates a candidate boarding site for the at least one user, the control apparatus being configured to:
extract, from the plurality of users, users with a common point of interest as users to be boarded together to a vehicle, based on first information which indicates a point of interest for each of the plurality of users; and
calculate a driving route for the vehicle to travel sequentially through candidate boarding sites for the extracted users to arrive at the common point of interest indicated by the first information, the candidate boarding sites being indicated by second information which indicates a candidate for a boarding site for each of the plurality of users; and

receiving, from the control apparatus, a notification of the driving route, when the at least one user is included in the users extracted by the control apparatus.

A vehicle operation support method according to an embodiment disclosed herein includes:

receiving, by a terminal apparatus of at least one user in a plurality of users, a manipulation made by the at least one user to select a point of interest;

transmitting, by the terminal apparatus of the at least one user, information which indicates the point of interest selected by the at least one user and information which indicates a candidate boarding site for the at least one user, to a control apparatus;

extracting, by the control apparatus, users with a common point of interest to be boarded together to a vehicle, from the plurality of users, based on first information which indicates a point of interest for each of the plurality of users;

calculating, by the control apparatus, a driving route for the vehicle to travel sequentially through candidate boarding sites for the extracted users to arrive at the common point of interest for the extracted users as indicated by the first information, the candidate boarding sites being indicated by second information which indicates a candidate for a boarding site for each of the plurality of users; and

receiving, by terminal apparatuses of the extracted users, a notification of the driving route, from the control apparatus.

The present disclosure supports vehicle dispatch such that users who are interested in the same place are boarded together to the same vehicle, to thereby enable the users to readily have an opportunity to meet each other.

### BRIEF DESCRIPTION OF THE DRAWINGS

In the accompanying drawings:

FIG. 1 is a diagram illustrating a configuration of a system according to an embodiment disclosed herein;

FIG. 2 is a block diagram illustrating a configuration of a control apparatus according to an embodiment disclosed herein;

FIG. 3 is a block diagram illustrating a configuration of a terminal apparatus according to an embodiment disclosed herein;

FIG. 4 is an example of a table according to an embodiment disclosed herein; and

FIG. 5 is a flowchart of an operation of a system according to an embodiment disclosed herein.

### DETAILED DESCRIPTION

An embodiment disclosed herein will be explained in below, with reference to the drawings.

In the drawings, the same or corresponding components are denoted herein by the same numerals. In the description of the disclosed embodiment, descriptions of the same or corresponding components are simplified or omitted as appropriate.

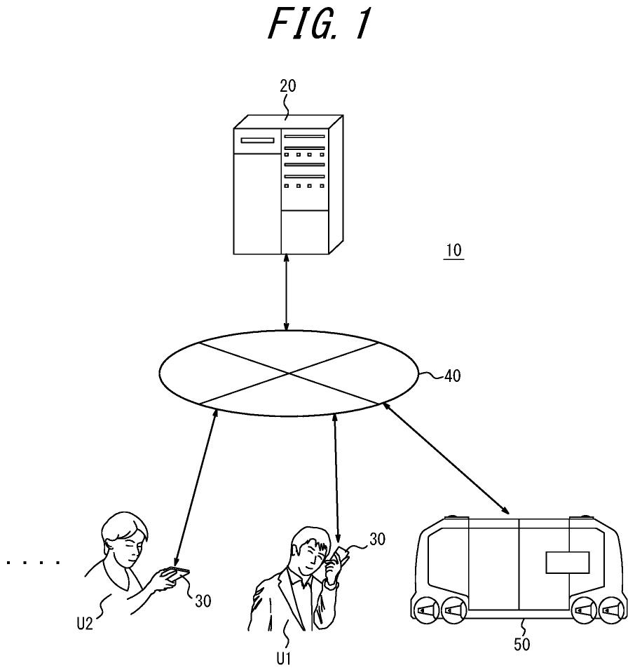

The configuration of the system 10 according to the disclosed embodiment is explained with reference to FIG. 1.

The system 10 according to the disclosed embodiment includes: at least one control apparatus 20; a terminal apparatus 30 for each of a plurality of users that includes a user U1 and a user U2; and at least one vehicle 50.

The control apparatus 20 is capable of communicating with the terminal apparatuses 30 via a network 40. The control apparatus 20 may be capable of communicating with the vehicle 50.

The network 40 includes the Internet, at least one WAN, at least one MAN, or a combination thereof. “WAN” is an abbreviation of wide area network. “MAN” is an abbreviation of metropolitan area network. The network 40 may include at least one wireless network, at least one optical network, or a combination thereof. Examples of the wireless network include an ad hoc network, a cellular network, a wireless LAN, a satellite communication network, and a terrestrial microwave network. “LAN” is an abbreviation of local area network.

The control apparatus 20 is installed in a facility such as a data center. The control apparatus 20 is a server which belongs to a cloud computing system or other computing systems.

The terminal apparatuses 30 are held by each of the plurality of users that includes the user U1 and the user U2. Examples of the terminal apparatuses 30 include a mobile apparatus such as a mobile phone, a smartphone or a tablet, and a PC. “PC” is an abbreviation of personal computer.

In the disclosed embodiment, the vehicle 50 is an on-demand bus. The vehicle 50 may be any other automobile other than the on-demand bus, such as a taxi, as long as it is capable of carrying at least two users in the plurality of users that includes the user U1 and the user U2. Examples of the vehicle 50 may include any kind of automobile, such as a gasoline car, a diesel car, HV, PHV, EV, and FCV. “HV” is an abbreviation of hybrid vehicle. “PHV” is an abbreviation of plug-in hybrid vehicle. “EV” is an abbreviation of electric vehicle. “FCV” is an abbreviation of fuel cell vehicle. The vehicle 50, which is driven by a driver in the disclosed embodiment, may be automated at any level. The level of automation is, for example, one of Level 1 to Level 5 according to the classification of the SAE. “SAE” is an abbreviation of Society of Automotive Engineers. The vehicle 50 may be a multi-purpose autonomous driving EV for MaaS. “MaaS” is an abbreviation of Mobility as a Service.

An outline of the disclosed embodiment is explained with reference to FIG. 1.

In the system 10 according to the disclosed embodiment, the terminal apparatus 30 of at least one user in the plurality of users that includes the user U1 and the user U2 receives a manipulation made by the at least one user to select a point of interest. The terminal apparatus 30 of the at least one user transmits information which indicates the point of interest selected by the at least one user and information which indicates a candidate boarding site for the at least one user, to the control apparatus 20. The control apparatus 20 extracts, from the plurality of users that includes the user U1 and the user U2, users with a common point of interest as users to be boarded together to the vehicle 50, based on first information which indicates a point of interest for each of the plurality of users. The control apparatus 20 calculates a driving route for the vehicle 50 to travel sequentially through the candidate boarding sites for the extracted users to arrive at the point of interest common to the extracted users as indicated by the first information, the candidate boarding sites being indicated by second information which indicates a candidate boarding site for each of the plurality of users that includes the user U1 and the user U2. The control apparatus 20 notifies the driving route thus calculated, to the terminal apparatuses 30 of the extracted users.

The disclosed embodiment supports vehicle dispatch such that users who are interested in the same place are boarded together to the same vehicle, to thereby enable the users to readily have an opportunity to meet each other.

As one modified example of the disclosed embodiment, the control apparatus 20 may further extract, from the plurality of users that includes the user U1 and the user U2, users who have a hobby related to the common point of interest as users to be boarded together to the vehicle 50, based on third information which indicates a hobby of each of the plurality of users.

The “point of interest” (which may also be referred to as POI hereinafter) refers to a specific place or facility in which a user is interested. In the disclosed embodiment, a specific place or facility in which each of the plurality of users that includes the user U1 and the user U2 is interested corresponds to a “POI”. Examples of a POI include: a place such as a ski resort, a sightseeing spot, and an event site; and a facility such as an eating and/or drinking facility, a leisure facility, a transportation facility, and an accommodation facility. Examples of an eating and/or drinking facility include a restaurant and a cafe. Examples of a leisure facility include a museum, a gallery, a theater, and an amusement park. Examples of a transportation facility include a station and an airport. Examples of an accommodation facility include a hotel and a condominium. The “boarding site” is a given site at which a user is boarded to the vehicle 50. The “candidate boarding site” is a candidate for a boarding site for a user. In the disclosed embodiment, a candidate for a boarding site for each of the plurality of users that includes the user U1 and the user U2 corresponds to the “candidate boarding sites”. Examples of a candidate boarding site include a house of a user, a site at which a user is present, and a site at which a user desires to board the vehicle 50.

The “first information” is information that indicates a POI for each of the plurality of users. The first information includes, for example, the position information or the name of a POI for the user. The “second information” is information that indicates, for each user, a candidate boarding site which is a candidate for a boarding site for each of the plurality of users. The second information includes, for example, the position information or the name of a site at which a user is present, the position information of a house of a user, or the position information or the name of a given site selected by a user. The “third information” is information that indicates a hobby of each of the plurality of users. The third information includes, for example, the name of a hobby of a user. The “position information” is, for example, an address, or a two dimensional coordinate, such as a longitude and a latitude, or a three dimensional coordinate.

In the disclosed embodiment, the first information, the second information, and the third information are stored in a table of a database, as will be described later.

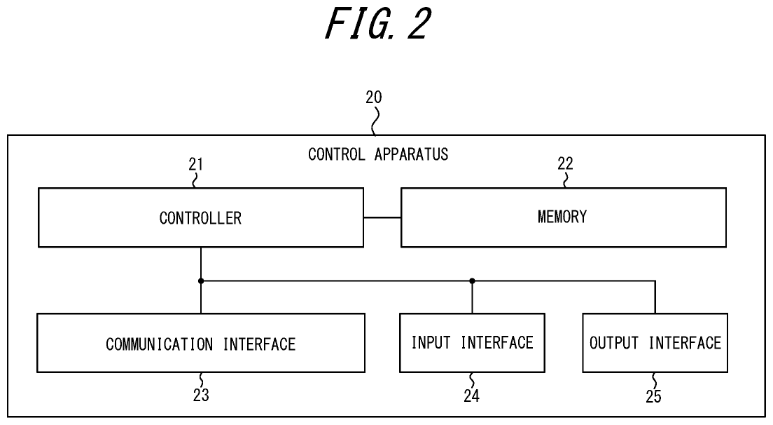

A configuration of the control apparatus 20 according to the disclosed embodiment is explained with reference to FIG. 2.

The control apparatus 20 includes: a controller 21; a memory 22; a communication interface 23; an input interface 24; and an output interface 25.

The controller 21 includes: at least one processor; at least one dedicated circuit; or a combination thereof. Examples of the processor include a general-purpose processor such as CPU or GPU, and a dedicated processor dedicated to specific processing. “CPU” is an abbreviation of central processing unit. “GPU” is an abbreviation of graphics processing unit. Examples of the dedicated circuit include an FPGA and an ASIC. “FPGA” of an abbreviation of field-programmable gate array. “ASIC” is an abbreviation of application specific integrated circuit. The controller 21 controls each component of the control apparatus 20 to execute processing related to the operations of the control apparatus 20.

The memory 22 includes: at least one semiconductor memory; at least one magnetic memory; at least one optical memory; or a combination of at least two of these kinds of memories. Examples of the semiconductor memory include RAM and ROM. “RAM” is an abbreviation of random access memory. “ROM” is an abbreviation of read only memory. Examples of RAM include SRAM and DRAM. “SRAM” is an abbreviation of static random access memory. “DRAM” is an abbreviation of dynamic random access memory. An example of ROM is EEPROM. “EEPROM” is an abbreviation of electrically erasable programmable read only memory. The memory 22 functions as, for example, a main memory, an auxiliary memory, or a cache memory. The memory 22 stores information for use in operations of the control apparatus 20 and information resulting from operations of the control apparatus 20. The aforementioned database, which is constructed in the memory 22 in the disclosed embodiment, may be constructed in an external storage apparatus.

The communication interface 23 includes at least one interface for communication. An example of the interface for communication is a LAN interface. The communication interface 23 receives information for use in operations of the control apparatus 20, or transmits information resulting from operations of the control apparatus 20.

The input interface 24 includes at least one interface for input. Examples of the interface for input include: a physical key; an electrostatic capacitance key; a pointing device; a touch screen integrally provided with a display; and a microphone. The input interface 24 receives a manipulation to input information for use in operations of the control apparatus 20. The input interface 24 may be connected to the control apparatus 20 as external input equipment, instead of being provided to the control apparatus 20. The connection may be established through any communication method such as USB, HDMI® (HDMI is a registered trademark in Japan, other countries, or both), or Bluetooth® (Bluetooth is a registered trademark in Japan, other countries, or both). “USB” is an abbreviation of Universal Serial Bus. “HDMI®” is an abbreviation of High-Definition Multimedia Interface.

The output interface 25 includes at least one interface for output. Examples of the interface for output include a display and a speaker. Examples of the display include an LCD and an organic EL display. “LCD” is an abbreviation of liquid crystal display. “EL” is an abbreviation of electro luminescence. The output interface 25 outputs information resulting from operations of the control apparatus 20. The output interface 25 may be connected to the control apparatus 20 as external output equipment, instead of being provided to the control apparatus 20. The connection may be established through any communication module such as USB, HDMI®, or Bluetooth®.

Functions of the control apparatus 20 are implemented by execution of the control program according to the disclosed embodiment, by a processor corresponding to the controller 21. In other words, functions of the control apparatus 20 are implemented by software. The control program causes a computer to execute operations of the control apparatus 20, to thereby cause the computer to function as the control apparatus 20. In other words, the computer executes operations of the control apparatus 20 according to the control program, to thereby function as the control apparatus 20.

The program may be stored in a non-transitory computer-readable medium. Examples of the non-transitory computer-readable medium include a magnetic storage device, an optical disc, a magneto-optical storage device, and ROM. The program is distributed by sale, transfer of ownership, or rental of a portable medium, such as a DVD or a CD-ROM, on which the program is stored. “DVD” is an abbreviation of digital versatile disc. “CD-ROM” is an abbreviation of compact disc read only memory. The program may be stored in storage in a server and distributed by transferring the program from the server to another computer.

For example, the computer temporarily stores, in a main storage device, a program stored in a portable medium or a program transferred from a server. The computer then reads out the program stored in the main storage device using a processor, and executes processing according to the program thus read out. The computer may read out a program directly from the portable medium and execute processing according to the program. Each time a program is transferred from the server to the computer, the computer may execute processing according to the received program in order. The processing may be executed through a so-called ASP-type service which implements functions merely by execution of instructions and acquisition of results, without transferring the program from the server to the computer. “ASP” is an abbreviation of application service provider. The program includes information for use in processing by an electronic computer, equivalent to the program. For example, data which is not a direct instruction to a computer but has properties that define the processing of the computer corresponds to the “information equivalent to the program”.

Some or all of the functions of the control apparatus 20 may be implemented by a dedicated circuit corresponding to the controller 21. That is, some or all of the functions of the control apparatus 20 may be implemented by hardware.

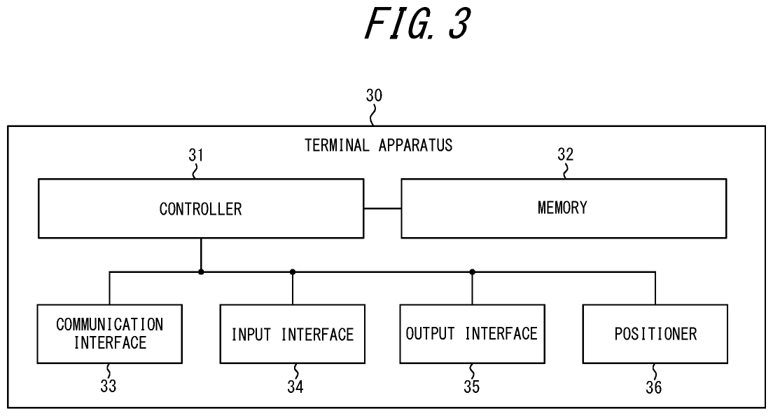

The configuration of the terminal apparatus 30 according to the disclosed embodiment is explained with reference to FIG. 3.

The terminal apparatus 30 includes: a controller 31; a memory 32; a communication interface 33; an input interface 34; an output interface 35; and a positioner 36.

The controller 31 includes: at least one processor; at least one dedicated circuit; or a combination thereof. Examples of the processor include a general-purpose processor such as a CPU or a GPU, and a dedicated processor dedicated to specific processing. Examples of the dedicated circuit include an FPGA and an ASIC. The controller 31 controls each component of the terminal apparatus 30 to execute processing related to the operations of the terminal apparatus 30.

The memory 32 includes: at least one semiconductor memory; at least one magnetic memory; at least one optical memory; or a combination of at least two of these kinds of memories. Examples of the semiconductor memory include RAM and ROM. Examples of RAM include SRAM and DRAM. An example of ROM includes EEPROM. The memory 32 functions as, for example, a main memory device, or a cache memory. The memory 32 stores information for use in operations of the terminal apparatus 30 and information resulting from operations of the terminal apparatus 30.

The communication interface 33 includes at least one interface for communication. Examples of the interface for communication include: an interface conforming to mobile communication standards such as LTE, 4G, or 5G; an interface conforming to near field communication standards such as Bluetooth®; and a LAN interface. “LTE” is an abbreviation of Long Term Evolution. “4G” is an abbreviation of 4th generation. “5G” is an abbreviation of 5th generation. The communication interface 33 receives information for use in operations of the terminal apparatus 30 and transmits information resulting from operations of the terminal apparatus 30.

The input interface 34 includes at least one interface for input. Examples of the interface for input include: a physical key; an electrostatic capacitance key; a pointing device; a touch screen integrally provided with a display; and a microphone. The input interface 34 receives a manipulation input information for use in operations of the terminal apparatus 30. The input interface 34 may be connected to the terminal apparatus 30 as external input equipment, instead of being provided to the terminal apparatus 30. The connection may be established through any communication method such as USB, HDMI®, or Bluetooth®.

The output interface 35 includes at least one interface for output. Examples of the interface for output include a display and a speaker. Examples of the display include an LCD and an organic EL display. The output interface 35 outputs information resulting from operations of the terminal apparatus 30. The output interface 35 may be connected as external equipment to the terminal apparatus 30, instead of being provided to the terminal apparatus 30. The connection may be established through any communication module such as USB, HDMI®, or Bluetooth®.

The positioner 36 includes at least one GNSS receiver. “GNSS” stands for global navigation satellite system. Examples of GNSS include: GPS; QZSS; GLONASS; and Galileo. “GPS” is an abbreviation of Global Positioning System. “QZSS” is an abbreviation of Quasi-Zenith Satellite System. The satellites for QZSS are known as quasi-zenith satellites. “GLONASS” is an abbreviation of Global Navigation Satellite System. The positioner 36 measures the position of the terminal apparatus 30. In the disclosed embodiment, the positioner 36 measures the position of the terminal apparatus 30, and acquires position information which indicates the measured position as the position information of the user of the terminal apparatus 30.

Functions of the terminal apparatus 30 are implemented by execution of the terminal program according to the disclosed embodiment, by a processor corresponding to the controller 31. In other words, functions of the terminal apparatus 30 are implemented by software. The control program causes a computer to execute operations of the terminal apparatus 30, to thereby cause the computer to function as the terminal apparatus 30. In other words, the computer executes operations of the terminal apparatus 30 according to the terminal program, to thereby function as the terminal apparatus 30.

Some or all of the functions of the terminal apparatus 30 may be implemented by a dedicated circuit corresponding to the controller 31. That is, some or all of the functions of the terminal apparatus 30 may be implemented by hardware.

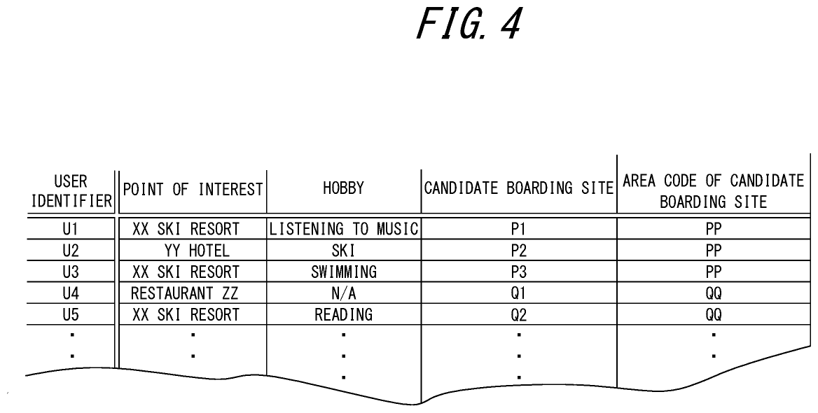

A configuration example of a table storing the first information, the second information, and the third information is explained with reference to FIG. 4.

A plurality of records are stored in the table of FIG. 4. Each record includes a user identifier for identifying a user, a POI for the user, a hobby of the user, a candidate boarding site for the user, and the area code of the candidate boarding site for the user. In other words, the table of FIG. 4 stores the first information in two columns including the user identifier column and the POI column. The table of FIG. 4 stores the second information in two columns including the user identifier column and the candidate boarding site column. The table of FIG. 4 stores the third information in two columns including the user identifier column and the hobby column. The table stores, in the column for the area codes of the candidate boarding sites, a code of an area where the candidate boarding site for each user is located. The “area” may be any area; examples of the area may include a prefecture and a city. The same code is assigned to the same area.

For example, the record of the first row includes: a user identifier “U1” for identifying the user U1; “XX SKI RESORT” as the name of the POI for the user U1; “LISTENING TO MUSIC” as the hobby of the user U1; and position information “P1” for the house of the user U1 as the candidate boarding site for the user U1. The record of the second row includes: a user identifier “U2” for identifying the user U2; “YY HOTEL” as the name of the POI for the user U2; “SKI” as the hobby of the user U2; and position information “P2” for the site selected by the user U2 as the candidate boarding site for the user U2. The record of the third row includes: a user identifier “U3” for identifying the user U3; “XX SKI RESORT” as the name of the POI for the user U3; “SWIMMING” as the hobby of the user U3; and position information “P3” for the house of the user U3 as the candidate boarding site for the user U3. The record of the forth row includes: a user identifier “U4” for identifying the user U4; “RESTAURANT ZZ” as the name of the POI for the user U4; and position information “Q1” for the house of the user U4 as the candidate boarding site for the user U4. The hobby of the user U4 is unregistered. The record of the fifth row includes: a user identifier “U5” for identifying the user U5; “XX SKI RESORT” as the name of the POI for the user U5; “READING” as the hobby of the user U5; and position information “Q2” for the house of the user U5 as the candidate boarding site for the user U5. In this example, the candidate boarding sites for the user U1, the user U2, and the user U3 fall within an area indicated by the area code of “PP”, and the candidate boarding sites for the user U4 and the user U5 fall within an area indicated by the area code “QQ”.

In the disclosed embodiment, the third information may not be stored in the table, as long as at least the first information and the second information are stored in the table.

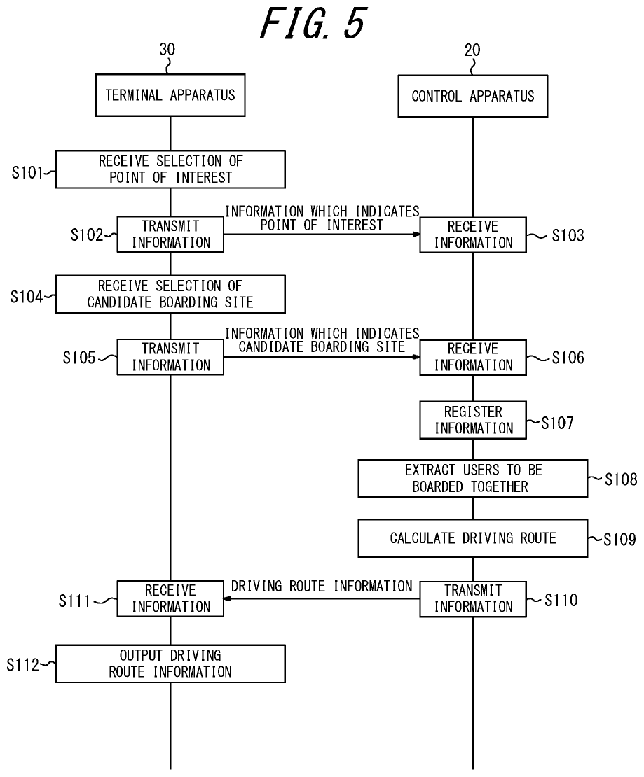

The operations of the system 10 according to the disclosed embodiment are explained with reference to FIG. 5. The operations correspond to the vehicle operation support method according to the disclosed embodiment. FIG. 5 illustrates operations of the control apparatus 20 and the operations of the terminal apparatus 30 of the user U1.

For convenience, the explanation is given on the premise that the records other than the record of the first row of the table of FIG. 4 have already been stored therein prior to Step S101 of FIG. 5. Each item of the records from the second row to the fifth row may be registered in the table through the same processing as the processing from Step S101 to Step S107 below. Alternatively, information for each item of the records from the second row to the fifth row may be acquired from the users through an interview with an operator over the phone, and the operator who interviewed the user may register the information acquired through the interview, in the table.

In Step S101 of FIG. 5, the controller 31 of the terminal apparatus 30 receives a manipulation made by at least one user in a plurality of users to select a POI. Specifically, the controller 31 of the terminal apparatus 30 receives a manipulation made by the user U1 to select a POI via the input interface 34 such as a touch screen or a microphone.

The POI may be selected by any procedure. In the disclosed embodiment, the POI is selected by the following procedure.

As an example, the POI of the user U1 is “XX SKI RESORT”. When the user U1 makes a manipulation to tap the site at which the “XX SKI RESORT” is found on a map displayed on a touch screen corresponding to the input interface 34, the controller 31 of the terminal apparatus 30 receives such manipulation as an operation select the “XX SKI RESORT” as the POI for the user U1. The “example” herein is intended to support the understanding of the disclosed embodiment, rather than to limit the disclosure.

In Step S102 of FIG. 5, the controller 31 of the terminal apparatus 30 transmits, to the control apparatus 20, information which indicates the POI selected in Step S101. Specifically, the controller 31 of the terminal apparatus 30 transmits, to the control apparatus 20, information which indicates the POI selected by the user U1, via the communication interface 33.

In an example, the controller 31 of the terminal apparatus 30 transmits, to the control apparatus 20, information including the name “XX SKI RESORT”.

In Step S103 of FIG. 5, the controller 21 of the control apparatus 20 receives information transmitted in Step S102. Specifically, the controller 21 of the control apparatus 20 receives, via the communication interface 23, information which indicates the POI of the user U1 and is transmitted from the terminal apparatus 30.

In an example, the controller 21 of the control apparatus 20 receives information including the name “XX SKI RESORT”.

In Step S104 of FIG. 5, the controller 31 of the terminal apparatus 30 receives a manipulation made by at least one user in the plurality of users, to select a candidate boarding site. Specifically, the controller 31 of the terminal apparatus 30 receives an operation made by the user U1 for selecting a candidate boarding site for the user U1, via an input interface 34 such as a touch screen or a microphone.

The candidate boarding site may be selected by any procedure. In the disclosed embodiment, the candidate boarding site is selected by the following procedure.

In an example, the candidate boarding site for the user U1 is the house of the user U1. When the user U1 performs a manipulation to tap the site where the house of the user U1 is found on the map displayed on a touch screen corresponding to the input interface 34, the controller 31 of the terminal apparatus 30 receives the manipulation as an operation to select the house of the user U1 as the candidate boarding site for the user U1.

In Step S105 of FIG. 5, the controller 31 of the terminal apparatus 30 transmits, to the control apparatus 20, information which indicates the candidate boarding site selected in Step S104. Specifically, the controller 31 of the terminal apparatus 30 transmits, to the control apparatus 20, information which indicates the candidate boarding site selected by the user U1, via the communication interface 33.

In an example, the controller 31 of the terminal apparatus 30 transmits, to the control apparatus 20, position information P1 of the house of the user U1, which is the site on the map tapped by the user U1.

In Step S106 of FIG. 5, the controller 21 of the control apparatus 20 receives information transmitted in Step S105. Specifically, controller 21 of the control apparatus 20 receives, via the communication interface 23, information which indicates the candidate boarding site for the user U1 and is transmitted from the terminal apparatus 30.

In an example, the controller 21 of the control apparatus 20 receives the position information for the house of the user U1.

In Step S107 of FIG. 5, the controller 21 of the control apparatus 20 stores the information received in Step S103 and the information received in Step S106, in the table of the database. Specifically, the controller 21 of the control apparatus 20 stores, in the table, information which indicates the POI for the user U1 and the information which indicates the candidate boarding site for the user U1.

In an example, the controller 21 of the control apparatus 20 adds, to the table, a new record including: the user identifier “U1” for identifying the user U1; the name “XX SKI RESORT” included in the information which indicates the POI for the user U1; and the position information “P1” for the house of the user U1 as the information which indicates the candidate boarding site for the user U1.

In Step S108 of FIG. 5, the controller 21 of the control apparatus 20 extracts, from the plurality of users, users with a common POI as users to be boarded together to the vehicle 50, based on the first information which indicates the POI for each of the plurality of users. Specifically, the controller 21 of the control apparatus 20 refers to the first information stored in the table, and extracts, from the plurality of users that includes the user U1 and the user U2, users who are interested in the same POI.

In an example, the controller 21 of the control apparatus 20 refers to the table of FIG. 4, and extracts, from the user U1 to user U5, the user U1, the user U3, and the user U5, who share “XX SKI RESORT” as a common POI, as users to be boarded together to the vehicle 50.

In Step S109 of FIG. 5, the controller 21 of the control apparatus 20 calculates a driving route for the vehicle 50 to travel sequentially through the candidate boarding sites for the extracted users to arrive at the common POI for the extracted users as indicated by the first information, the candidate boarding sites being indicated by the second information which indicates a candidate for a boarding site for each of the plurality of users. Specifically, the controller 21 of the control apparatus 20 refers to the second information stored in the table, and calculates a driving route for the vehicle 50 to travel sequentially through the candidate boarding sites for the users extracted in Step S108 to arrive at the common POI for the extracted users.

In an example, the controller 21 of the control apparatus 20 refers to the table of FIG. 4, and calculates a driving route for the vehicle 50 to travel sequentially through the house of the user U1, the house of the user U3, and the house of the user U5, as the candidate boarding sites for the user U1, the user U3, and the user U5, to arrive at the “XX SKI RESORT” as the common POI for the user U1, the user U3, and the user U5. The candidate boarding sites may be travelled through in any order; however, the order may desirably be optimized so as to minimize the length of the driving route or the driving time for the vehicle 50.

In Step S110 of FIG. 5, the controller 21 of the control apparatus 20 notifies the driving route calculated in Step S109 to the terminal apparatus 30 of each of the users extracted in Step S108. Specifically, the controller 21 of the control apparatus 20 transmits, to the terminal apparatus 30 of each of the users extracted in Step S108, the notification of the driving route for the vehicle 50 as the driving route information, via the communication interface 23.

In an example, the controller 21 of the control apparatus 20 transmits the driving route information to the terminal apparatus 30 of each of the user U1, the user U3, and the user U5.

In Step S111 of FIG. 5, the controller 31 of the terminal apparatus 30 receives the notification of the driving route, from the control apparatus 20, in a case in which the user who made the manipulation in Step S101 is included in the users extracted by the control apparatus 20 in Step S108. Specifically, the controller 31 of the terminal apparatus 30 receives, from the control apparatus 20, the driving route information via the communication interface 33, in a case in which the user U1 is included in the users extracted by the control apparatus 20 as users to be boarded together on the vehicle 50.

In an example, the user U1 is included in the users U1, the user U3, and the user U5 extracted by the control apparatus 20. Thus, the controller 31 of the terminal apparatus 30 receives the driving route information, from the control apparatus 20.

In Step S112 of FIG. 5, the controller 31 of the terminal apparatus 30 outputs the notification of the driving route received from the control apparatus 20 in Step S111. Specifically, the controller 31 of the terminal apparatus 30 outputs the driving route information received from control apparatus 20, through the output interface 35 such as a display or a speaker.

In an example, the controller 31 of the terminal apparatus 30 displays, on the display corresponding to the output interface 35, the driving route for travelling sequentially through the houses of the user U1, the user U3, and the user U5 as the candidate boarding sites for the user U1, the user U3, and the user U5, to arrive at the “XX SKI RESORT” as the common POI for the user U1, the user U3, and the user U5. The controller 31 may output the driving route by voice from a speaker corresponding to the output interface 35 to guide the vehicle 50.

As described above, according to the disclosed embodiment, the controller 21 of the control apparatus 20 extracts, from a plurality of users that includes users U1 to U5, the user U1, the user U3, and the user U5 with a common POI as users to be boarded together to the vehicle 50, based on the first information which indicates a POI of each of the plurality of users. The controller 21 calculates a driving route for the vehicle 50 to travel sequentially through the candidate boarding sites for the extracted users U1, U3, and U5 to arrive at the common POI for the extracted users U1, U3, and U5, as indicated by the first information, the candidate boarding sites being indicated by second information which indicates a candidate for a boarding site for each of the plurality of users.

According to the disclosed embodiment, dispatch of the vehicle 50 is supported such that the users U1, U3, and U5 who are interested in the same place are boarded together to the same vehicle 50, to thereby enable the users U1, U3, and U5 to readily have an opportunity to meet one another.

In the disclosed embodiment, the controller 31 of the terminal apparatus 30 receives, via the input interface 34, a manipulation to select a POI by at least one user including the user U1 in the plurality of users that includes the user U1 to the user U5. The controller 31 transmits, to the control apparatus 20, information which indicates the POI selected by the at least one user and information which indicates the candidate boarding site for the at least one user, via the communication interface 33. The controller 31 receives the notification of the driving route, in a case in which the at least one user is included in the users U1, U3, and U5 extracted by the control apparatus 20 as users to be boarded together to the vehicle 50.

The disclosed embodiment enables the users U1, U3, and U5 who are interested in the same place to be boarded together to the same vehicle 50, to thereby have an opportunity to meet each other even if the users U1, U3, and U5 do not originally belong to the same group.

In the disclosed embodiment, the controller 31 of the terminal apparatus 30 receives, as a manipulation made by the user U1 to select a POI, a manipulation made by the user U1 to select a POI of the user U1 on a map. The controller 21 of the control apparatus 20 includes, in the first information, information which indicates a site selected on a map by the user U1, as the POI for the user U1.

According to the disclosed embodiment, registration of a POI is simplified.

As a modified example of the disclosed embodiment, the controller 31 of the terminal apparatus 30 may receive, as a manipulation made by the user U1 select the POI, a manipulation made by the user U1 to select a picture related to the POI. In this case, the controller 21 of the control apparatus 20 identifies a site related to the picture selected by the user U1, and includes, in the first information, information which indicates the identified site as the POI for the user U1. For example, the controller 21 may identify a site where the picture was taken as the site related to the picture, or may identify a facility dealing with the subject of the picture as the POI related to the picture.

In Step S101 of FIG. 5, when the user U1 performs an approval manipulation such as “Like!” for a picture taken at the “XX SKI RESORT”, among pictures viewed on websites, pictures stored in the terminal apparatus 30, or pictures distributed through the network 50, the controller 31 of the terminal apparatus 30 receives such manipulation as an operation to select “XX SKI RESORT” as the POI for the user U1. In Step S102 of FIG. 5, the controller 31 transmits, to the control apparatus 20, the picture selected by the user U1 or information for identifying the picture, as the information which indicates the POI of the user U1. In Step S103 of FIG. 5, the controller 21 of the control apparatus 20 receives the picture or the information for identifying the picture transmitted from the terminal apparatus 30. In a case in which information which indicates the “XX SKI RESORT” as the place where the picture is taken is attached as meta-data to the picture or any picture similar to the picture is posted on the website of the “XX SKI RESORT”, the controller 21 refers to such meta-data or to the website, to thereby identify the site “XX SKI RESORT” where the picture was taken as the site related to the picture. Alternatively, when a specific product sold at any shop in the “XX SKI RESORT” is taken as the subject in the picture, the controller 21 identifies the shop in the “XX SKI RESORT” as a facility dealing with the product, as the site related to the picture. In Step S107, the controller 21 of the control apparatus 20 adds, to the table, a new record including the name “XX SKI RESORT” identified from information which indicates the user U1, rather than being included in the information which indicates the POI of the user U1.

According to this modified example, the POI can be identified based on a picture selected by the user, which enables the user to select the POI more intuitively.

As a modified example of the disclosed embodiment, the controller 31 of the terminal apparatus 30 may receive, as the manipulation made by the user to select the POI, a manipulation made by the user for selecting a facility. In this case, the controller 21 of the control apparatus 20 includes, in the first information, information which indicates the facility selected by the user U1 as the POI of the user U1.

In Step S101 of FIG. 5, when the user U1 makes a manipulation by inputting “XX SKI RESORT” by text as the name of a facility or makes a manipulation to select “XX SKI RESORT” as the name of a facility from a pull-down menu in a website which posts sightseeing information, the controller 31 of the terminal apparatus 30 receives such manipulation as an operation to select the “XX SKI RESORT” as the POI of the user U1. In Step S102 of FIG. 5, the controller 31 transmits information including the name of “XX SKI RESORT” to the control apparatus 20. In Step S103 of FIG. 5, the controller 21 of the control apparatus 20 receives information including the name of “XX SKI RESORT” transmitted from the terminal apparatus 30.

This modified example enables the user to select the POI based on the name of the facility, without knowing where the facility is located.

As a modified example of the disclosed embodiment, the control apparatus 20 may acquire, from user information which indicates the position information for the houses of the plurality of users that includes the user U1, information which indicates the house of the user U1 as the candidate boarding site for the user U1, instead of receiving information which indicates the candidate boarding site of the user U1 from the terminal apparatus 30, and include the acquired information in the second information.

The user information may be stored in advance in the memory 22 of the control apparatus 20 or may be accumulated in an external system such as GIS on the Internet. “GIS” is an abbreviation of geographic information system. The user information may include position information for the houses of a plurality of users and information which indicates the office, mail address, phone number, and hobby of each of the plurality of users. In Step S107 of FIG. 5, the controller 21 of the control apparatus 20 acquires, from the user information, the position information P1 for the house of the user U1, and adds a new record including, as information which indicates the candidate boarding site of the user U1, the acquired position information P1 of the user U1, to the table. In this case, the processing from Step S104 to Step S106 may be omitted.

According to this modified example, registration of the candidate boarding site is simplified.

As a modified example of the disclosed embodiment, the controller 31 of the terminal apparatus 30 may transmit information which indicates the site where the user U1 is present, as the information which indicates the candidate boarding site for the user U1. In this case, the controller 21 of the control apparatus 20 acquires information which indicates the site where the user U1 is present and includes, in the second information, the site indicated by the acquired information as the candidate boarding site for the user U1.

In Step S104 of FIG. 5, the controller 31 of the terminal apparatus 30 measures the position of the terminal apparatus 30 of the user U1 using the positioner 36, instead of receiving the manipulation made by the user U1 to select the candidate boarding site for the user U1, and acquires the position information for the terminal apparatus 30 as the information which indicates the site where the user U1 is present. In Step S105 of FIG. 5, the controller 31 transmits, to the control apparatus 20, the acquired information which indicates the site where the user U1 is present, as the information which indicates the candidate boarding site for the user U1. In Step S106 of FIG. 5, the controller 21 of the control apparatus 20 receives the information which indicates the site where the user U1 is present, transmitted from the terminal apparatus 30. In Step S107 of FIG. 5, the controller 21 of the control apparatus 20 adds, to the table, a new record including information which indicates the site where the user U1 is present, as information which indicates the candidate boarding site of the user U1.

According to this modified example, specification of the candidate boarding site is simplified.

As a modified example of the disclosed embodiment, the controller 31 of the terminal apparatus 30 may receive, as the manipulation made by the user U1 to select the candidate boarding site, a manipulation made by the user U1 to select a boarding site desired by the user U1. In this case, the controller 21 of the control apparatus 20 acquires information which indicates the boarding site desired by the user U1, selected by the user U1, and includes, in the second information, information which indicates, as the candidate boarding site of the user, the boarding site indicated by the acquired information.

In Step S104 of FIG. 5, the user U1 is to select, as the boarding site desired by the user U1, the “WW bus stop” as the closest bus stop, from arbitrary sites such as bus stops and community centers. When the user U1 makes a manipulation to tap a site where the “WW bus stop” is located on a map displayed on a touch screen which corresponds to the input interface 34, the controller 31 of the terminal apparatus 30 receives such manipulation as an operation to select the candidate boarding site for the user U1. In Step S105 of FIG. 5, the controller 31 of the terminal apparatus 30 transmits, to the control apparatus 20, the position information of the “WW bus stop” as a site tapped on a map by the user U1, as the information which indicates the candidate boarding site for the user U1. In Step S106 of FIG. 5, the controller 21 of the control apparatus 20 receives the position information of the “WW bus stop” as the information which indicates the candidate boarding site for the user U1, transmitted from the terminal apparatus 30. In Step S107 of FIG. 5, the controller 21 adds, to the table, a new record including the position information of the “WW bus stop” as the information which indicates the candidate boarding site for the user U1.

According to this modified example, the user U1 can designate a site other than the house of the user U1 to board the vehicle 50.

As a modified example of the disclosed embodiment, the controller 21 of the control apparatus 20 may further extract, from the plurality of users that includes the user U1 to the user U5, a user who has a hobby related to the common POI for the plurality of users, as users to be boarded together to the vehicle 50, based on the third information which indicates the hobby of each of the plurality of users.

In Step S108 of FIG. 5, the controller 21 of the control apparatus 20 refers to the table of FIG. 4, and extracts, from the user U1 to the user U5, the user U2 who has the hobby “SKI”, which is related to the “XX SKI Resort” as the common POI for the users U1, U3, and U5, as the user to be boarded together to the vehicle 50.

According to this modified example, because a user who has a hobby related to the POI is extracted as a user to be boarded together to the vehicle 50, and not only the users with common POI, the opportunities for users to meet each other can be further expanded.

As a modified example of the disclosed embodiment, the controller 21 of the control apparatus 20 may select, from the users extracted as users to be boarded together to the vehicle 50, one or more users whose sites indicated by the second information fall within a prescribed range, and calculate the driving route to travel through the candidate boarding sites for the one or more users selected.

In Step S109 of FIG. 5, the controller 21 of the control apparatus 20 refers to the table of FIG. 4 and selects, from the users U1, U3, and U5 extracted as the users to be boarded together to the vehicle 50, one or more users whose site indicated by the second information fall within a prescribed range. The “prescribed range” may be arbitrarily determined. The prescribed range may be a range to be traveled within a predetermined time or distance, or may be one prefecture or city. In this modified example, users having the same area code for the candidate boarding sites are selected as the users whose sites fall within a prescribed range. Specifically, the controller 21 of the control apparatus 20 selects the user U1 and the user U3 who share the same area code of “PP” for their candidate boarding sites, and excludes the user U5 whose area code for the candidate boarding site is “QQ” which is different from “PP”. In Step S109 of FIG. 5, the controller 21 of the control apparatus 20 calculates a route for travelling sequentially through the candidate boarding sites for the user U1 and the user U3 selected to arrive at the “XX ski resort” as the POI, as a driving route.

According to this modified example, because the range of the candidate boarding sites for the users to be boarded together to the vehicle 50 is limited, efficient user transfer is possible.

As a modified example of the disclosed embodiment, the controller 21 of the control apparatus 20 may calculate a driving route in a case in which the number of the users to be boarded together on the vehicle 50 is equal to or larger than a threshold.

The threshold, which is “two” in this modified example, may be any value of two or more without being limited thereto. In Step S109 of FIG. 5, controller 21 of the control apparatus 20 does not calculate the driving route when the number of users to be boarded together on the vehicle 50 is less than two.

According to this modified example, the user to be boarded to the vehicle 50 will not be alone, which reliably provides an opportunity for the users who are interested in the same place to meet each other.

While the present disclosure has been described with reference to the drawings and examples, the present disclosure is not limited to the aforementioned embodiments, and may be subjected to various modifications and alterations based on the present disclosure. For example, the plurality of blocks in the block diagrams may be integrated, or each of the blocks may be divided. The plurality of steps in the flowchart may be executed in parallel or in different order according to the processing capability of the apparatus for executing each step, instead of being executed in chronological order as illustrated. The present disclosure may be changed without departing from the gist of the present disclosure. Therefore, it should be noted that such modifications and alterations should all fall within the scope of the present disclosure.

1. A control apparatus comprising a controller, wherein the controller is configured to:
extract, from a plurality of users, users with a common point of interest as users to be boarded together to a vehicle, based on first information which indicates a point of interest for each of the plurality of users; and
calculate a driving route for the vehicle to travel sequentially through candidate boarding sites for the extracted users to arrive at the common point of interest for the extracted users as indicated by the first information, the candidate boarding sites being indicated by second information which indicates a candidate for a boarding site for each of the plurality of users.

2. The control apparatus according to claim 1, wherein the controller is configured to include, in the first information, information which indicates a site selected on a map by at least one user in the plurality of users, as a point of interest for the at least one user.

3. The control apparatus according to claim 1, wherein the controller is configured to:
identify a site related to a picture selected by at least one user in the plurality of users; and
include, in the first information, information which indicates the identified site as a point of interest for the at least one user.

4. The control apparatus according to claim 3, wherein the controller is configured to identify, as the site related to the picture, a site at which the picture was taken.

5. The control apparatus according to claim 3, wherein the controller is configured to identify, as the site related to the picture, a facility which deals with a subject of the picture.

6. The control apparatus according to claim 1, wherein the controller is configured to include, in the first information, information which indicates, as the point of interest for the at least one user, a facility selected by at least one user in the plurality of users.

7. The control apparatus according to claim 1, wherein the controller is configured to include, in the second information, information which indicates, as a candidate boarding site of the at least one user, a house of at least one user in the plurality of users.

8. The control apparatus according to claim 1, wherein the controller is configured to:
acquire information which indicates a site at which at least one user in the plurality of users is present; and
include, in the second information, information which indicates, as a candidate boarding site for the at least one user, the site indicated by the acquired information.

9. The control apparatus according to claim 1, wherein the controller is configured to:
acquire information which indicates a boarding site desired by at least one user in the plurality of users; and
include, in the second information, information which indicates, as a candidate boarding site of the at least one user, the boarding site indicated by the acquired information.

10. The control apparatus according to claim 1, wherein the controller is configured to further extract, from the plurality of users, a user who has a hobby related to the common point of interest as a user to be boarded together to the vehicle, based on third information which indicates a hobby of each of the plurality of users.

11. The control apparatus according to claim 1, wherein the controller is configured to:
select, from the users extracted as the users to be boarded together to the vehicle, users whose candidate boarding sites fall within a prescribed range; and
calculate, as the driving route, a route for travelling sequentially through the candidate boarding sites for the selected users.

12. The control apparatus according to claim 1, wherein the controller is configured to calculate the driving route in a case in which the number of the users to be boarded together to the vehicle is equal to or larger than a threshold.

13. A system comprising:
the control apparatus according to claim 1; and
a terminal apparatus for each of the plurality of users, the terminal apparatus being configured to receive, from the control apparatus, a notification of the driving route.

14. A non-transitory computer-readable medium storing a program configured to cause a computer to execute operations, the operations comprising:
receiving a manipulation made by at least one user in a plurality of users to select a point of interest;
transmitting, to a control apparatus, information which indicates the point of interest selected by the at least one user and information which indicates a candidate boarding site for the at least one user, the control apparatus being configured to:
extract, from the plurality of users, users with a common point of interest as users to be boarded together to a vehicle, based on first information which indicates a point of interest for each of the plurality of users; and
calculate a driving route for the vehicle to travel sequentially through candidate boarding sites for the extracted users to arrive at the common point of interest for the extracted users as indicated by the first information, the candidate boarding sites being indicated by second information which indicates a candidate for a boarding site for each of the plurality of users; and
receiving, from the control apparatus, a notification of the driving route, when the at least one user is included in the users extracted by the control apparatus.

15. The non-transitory computer-readable medium according to claim 14, wherein the manipulation is an operation made by the at least one user to select, on a map, the point of interest for the at least one user.

16. The non-transitory computer-readable medium according to claim 14, wherein the manipulation is an operation made by the at least one user to select a picture related to the point of interest for the at least one user.

17. The non-transitory computer-readable medium according to claim 14, wherein the manipulation is an operation made by the at least one user to select a facility as the point of interest for the at least one user.

18. The non-transitory computer-readable medium according to claim 14, wherein the transmitting includes transmitting information which indicates a site at which the at least one user is present, as information which indicates the candidate boarding site for the at least one user.

19. A terminal apparatus configured to execute the operations according to the program stored in the non-transitory computer-readable medium of claim 14.

20. A vehicle operation support method comprising:
receiving, by a terminal apparatus of at least one user in a plurality of users, a manipulation made by the at least one user to select a point of interest;
transmitting, by the terminal apparatus of the at least one user, information which indicates the point of interest selected by the at least one user and information which indicates a candidate boarding site for the at least one user, to a control apparatus;
extracting, by the control apparatus, users with a common point of interest to be boarded together to a vehicle, from the plurality of users, based on first information which indicates a point of interest for each of the plurality of users;
calculating, by the control apparatus, a driving route for the vehicle to travel sequentially through candidate boarding sites for the extracted users to arrive at the common point of interest for the extracted users as indicated by the first information, the candidate boarding sites being indicated by second information which indicates a candidate for a boarding site for each of the plurality of users; and
receiving, by terminal apparatuses of the extracted users, a notification of the driving route, from the control apparatus.
